(19) United States
(12) Patent Application Publication
(10) Pub. No.: US 2019/0056591 A1
(43) Pub. Date: Feb. 21, 2019

(54) OPTICAL WAVEGUIDE WITH MULTIPLE ANTIREFLECTIVE COATINGS

(71) Applicant: Microsoft Technology Licensing, LLC, Redmond, WA (US)

(72) Inventors: Jani Kari Tapio TERVO, Espoo (FI); Pasi Petteri PIETILAE, Espoo (FI); Lauri Tuomas SAINIEMI, Espoo (FI); Pasi KOSTAMO, Espoo (FI); Ari Juhani TERVONEN, Vantaa (FI); Tommi Juhani RIEKKINEN, Espoo (FI)

(21) Appl. No.: 15/680,537

(22) Filed: Aug. 18, 2017

(51) Int. Cl. G02B 27/01; G02B 1/115; F21V 8/00

(52) U.S. Cl. CPC G02B 27/0172; G02B 1/115; G02B 2027/0125; G02B 6/0038; G02B 2027/0178; G02B 6/0016

(57) ABSTRACT

An optical waveguide that performs both in-coupling and out-coupling of projected light is provided. The out-coupling region of the waveguide comprises a single-sided or double-sided diffraction grating with at least one of the grating structures conformally coated with a high refractive index material. To reduce the unwanted reflection of light on the waveguide surfaces coated with the high refractive index material, additional antireflective coatings are applied to the diffraction grating areas with the high refractive index coating. The additional antireflective coatings may be very thin to avoid in-coupling, and therefore avoid interference in one or more light rays propagating in the optical waveguide. Alternatively, the antireflective coatings may be very thick to promote in-coupling such that the resulting interference becomes consistent across all light rays propagating in the optical waveguide.

### BACKGROUND

Optical waveguides can be used to expand or replicate the exit pupil of a display module in one or two dimensions. Typically, a plurality light rays from the display module is coupled in the waveguide through an in-coupling region and travel through the waveguide in directions determined by the original light ray direction and the waveguide parameters. The light rays exit the waveguide through an out-coupling region that is typically larger than the in-coupling region.

Current waveguides typically use optical elements such as crossed grating structures and double-sided gratings structures to in-couple and out-couple light. Crossed gratings are grating structures that are periodic in two dimensions, while double-sided gratings are grating structures that are located on both surfaces of the optical waveguide.

One way of providing grating structures is to replicate or imprint the grating structures on the waveguide using a photo curable resin and a suitable mold or master stamp. The provided grating structure may be covered with a high refractive index layer to improve the efficiency and angular bandwidth of the grating structure. However, such a high index layer on the grating structure may result in increased intensity of unwanted reflections in the optical waveguide assembly, which is undesirable.

### SUMMARY

An optical waveguide that performs both in-coupling and out-coupling of projected light is provided. The out-coupling region of the waveguide comprises a single-sided or double-sided diffraction relief grating structure with at least one of the grating structures conformally coated with a high refractive index material. To reduce the unwanted reflection of light on the waveguide surfaces coated with the high refractive index material, antireflective coatings are applied to the diffraction grating areas with the high refractive index coating. The applied antireflective coatings may be very thin to avoid in-coupling, and therefore avoid interference in one or more light rays propagating in the optical waveguide. Alternatively, the antireflective coatings may be very thick to promote in-coupling such that the resulting interference becomes consistent across all light rays propagating in the optical waveguide.

In an implementation, an optical waveguide is provided. The optical waveguide includes a light-transmissive substrate including a plurality of internally reflective surfaces; a first diffractive optical element formed on a first surface of the plurality of internally reflective surfaces, wherein the first diffractive optical element is adapted to in-couple light into the optical waveguide; and a second diffractive optical element formed on a second surface of the plurality of internally reflective surfaces and adapted to out-couple light from the optical waveguide. The second diffractive optical element includes: a diffraction relief grating structure having a first refractive index; a first coating having a second refractive index, wherein the diffraction relief grating structure is embedded in the first coating; and a plurality of further coatings. Each further coating is part of an antireflective coating structure and the refractive indices of each layer may be the same or different. The refractive indices may be optimized to minimize unwanted reflections.

In an implementation, an optical waveguide for providing pupil expansion for augmented reality and virtual reality applications is provided. The optical waveguide includes a light-transmissive substrate including a plurality of internally reflective surfaces; a first diffractive optical element formed on a first surface of the plurality of internally reflective surfaces, wherein the first diffractive optical element is adapted to in-couple light into the optical waveguide; and a second diffractive optical element formed on the first surface or a second surface of the plurality of internally reflective surfaces and adapted to out-couple light from the optical waveguide, wherein the second diffractive optical element includes: a diffraction relief grating structure; a first coating, wherein the diffraction relief grating structure is embedded in the first coating; and a plurality of second coatings forming an anti-reflective structure that reduces reflections associated with the first coating.

In an implementation, an optical waveguide is provided. The optical waveguide includes: a light-transmissive substrate including a plurality of internally reflective surfaces; and a diffractive optical element formed on a first surface of the plurality of internally reflective surfaces, wherein the diffractive optical element includes: a diffraction relief grating structure; a first coating, wherein the diffraction relief grating structure is embedded in the first coating; and a second coating, wherein the second coating reduces one or more reflections associated with the first coating.

In an implementation, a head mounted display device is provided. The head mounted display includes: a display module; a controller coupled to the display module and configured to cause the display module to project a beam of light; and an optical waveguide, wherein the optical waveguide includes: a light-transmissive substrate including a plurality of internally reflective surfaces; and a diffractive optical element formed on a surface of the plurality of internally reflective surfaces, wherein the diffractive optical element includes: a diffraction relief grating structure; a first coating, wherein the diffraction relief grating structure is embedded in the first coating; and a second coating, wherein the second coating reduces one or more reflections associated with the first coating.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, example constructions of the embodiments are shown in the drawings; however, the embodiments are not limited to the specific methods and instrumentalities disclosed. In the drawings:

FIG. 1 is an illustration of an exemplary head mounted display device;

FIG. 2 is an illustration of a perspective view of an exemplary near-eye display system;

FIG. 3 is an illustration of a side view of an exemplary near-eye display system;

FIGS. 4A, 4B, 4C are illustrations of a portion of an example grating structure with coatings; and

FIG. 5 is an operational flow of an implementation of a method for providing an optical waveguide including one or more grating structures with antireflective coatings comprising multiple layers.

### DETAILED DESCRIPTION

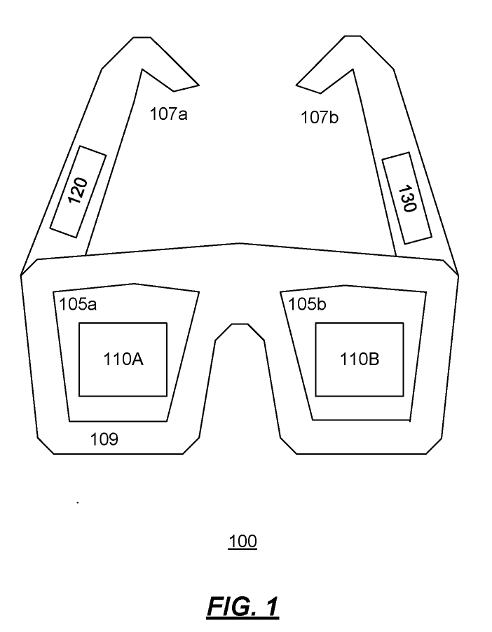

FIG. 1 is an illustration of an example head mounted display (“HMD”) device 100. In an implementation, the HMD device 100 is a pair of glasses. The HMD device 100 includes lenses 105a and 105b arranged within a frame 109. The frame 109 is connected to a pair of temples 107a and 107b. Arranged between each of the lenses 105 and a wearer's eyes is a near-eye display system 110. The system 110A is arranged in front of a right eye and behind the lens 105A. The system 110B is arranged in front of a left eye and behind the lens 105B. The HMD device 110 also includes a controller 120 and one or more sensors 130, The controller 120 may be a computing device operatively coupled to both near-eye display systems 110 and to the sensors 130.

Sensors 130 may be arranged in any suitable location on the HMD device 100. They may include a gyroscope or other inertial sensors, a global-positioning system (GPS) receiver, and/or a barometric pressure sensor configured for altimetry. These sensors 130 may provide data on the wearer's location or orientation. From the integrated responses of the sensors 130, the controller 120 may track the movement of the HMD device 100 within the wearer's environment.

In some implementations, sensors 130 may include an eye tracker that is configured to detect an ocular state of the wearer of the HMD device 100. The eye tracker may locate a line of sight of the wearer, measure an extent of iris closure, etc. If two eye trackers are included, one for each eye, then the two may be used together to determine the wearer's focal plane based on the point of convergence of the lines of sight of the wearer's left and right eyes. This information may be used by controller 120 for placement of a computer-generated display image, for example.

In some implementations, each near-eye display system 110 may be at least partly transparent, to provide a substantially unobstructed field of view in which the wearer can directly observe their physical surroundings. Each near-eye display system 110 may be configured to present, in the same field of view, a computer-generated display image.

The controller 120 may control the internal componentry of near-eye display systems 110A and 110B to form the desired display images. In an implementation, the controller 120 may cause near-eye display systems 110A and 110B to display approximately the same image concurrently, so that the wearer's right and left eyes receive the same image at approximately the same time. In other implementations, the near-eye display systems 110A and 110B may project somewhat different images concurrently, so that the wearer perceives a stereoscopic, i.e., three-dimensional, image.

In some implementations, the computer-generated display image and various real images of objects sighted through the near-eye display systems 110 may occupy different focal planes. Accordingly, the wearer observing a real-world object may shift their corneal focus to resolve the display image. In other implementations, the display image and at least one real image may share a common focal plane.

In the HMD device 100, each of the near-eye display systems 110A and HOB may also be configured to acquire video of the surroundings sighted by the wearer. The video may include depth video and may be used to establish the wearer's location, what the wearer sees, etc. The video acquired by each near-eye display system 110 may be received by the controller 120, and the controller 120 may be configured to process the video received. To this end, the HMD device 100 may include a camera. The optical axis of the camera may be aligned parallel to a line of sight of the wearer of the HMD device 100, such that the camera acquires video of the external imagery sighted by the wearer. As the HMD device 100 may include two near-eye display systems—one for each eye—it may also include two cameras. More generally, the nature and number of the cameras may differ in the various embodiments of this disclosure. One or more cameras may be configured to provide video from which a time-resolved sequence of three-dimensional depth maps is obtained via downstream processing.

No aspect of FIG. 1 is intended to be limiting in any sense, for numerous variants are contemplated as well. In some embodiments, for example, a vision system separate from the HMD device 100 may be used to acquire video of what the wearer sees. In some embodiments, a single near-eye display system 110 extending over both eyes may be used instead of the dual monocular near-eye display systems 110A and 110B shown in FIG. 1.

The HMD device 100 may be used to support a virtual-reality (“VR”) or augmented-reality (“AR”) environment for one or more participants. A realistic AR experience may be achieved with each AR participant viewing their environment naturally, through passive optics of the HMD device 100. Computer-generated imagery may be projected into the same field of view in which the real-world imagery is received. Imagery from both sources may appear to share the same physical space.

The controller 120 in the HMD device 100 may be configured to run one or more computer programs that support the VR or AR environment. In some implementations, one or more computer programs may run on the controller 120 of the HMD device 100, and others may run on an external computer accessible to the HMD device 100 via one or more wired or wireless communication links. Accordingly, the HMD device 100 may include suitable wireless componentry, such as Wi-Fi.

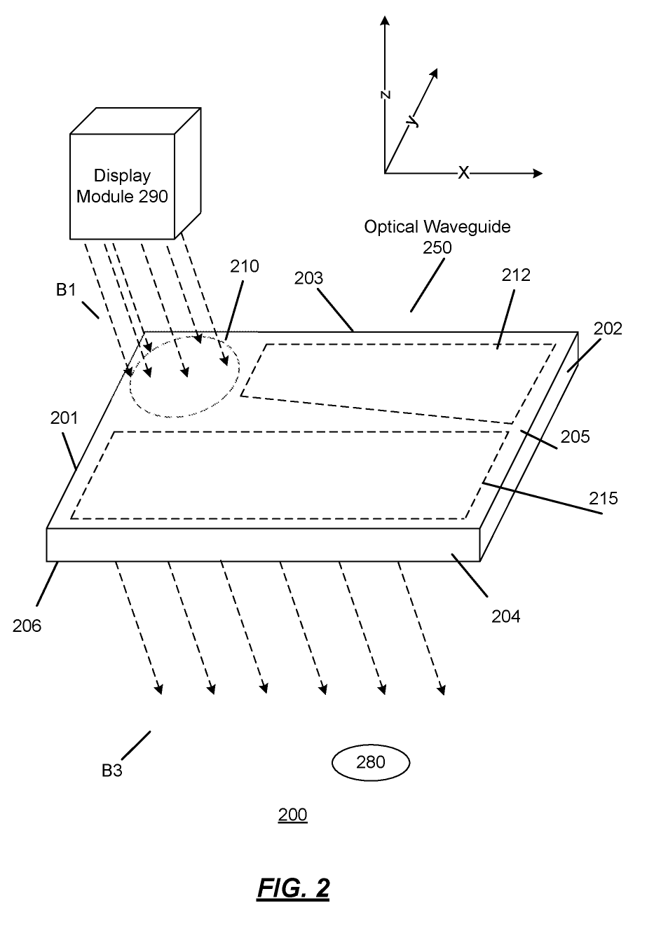

FIG. 2 is an illustration of a perspective view of an exemplary near-eye display system 200. The near-eye display system 200 may be an implementation of one or both of the near-eye display systems 110 shown in FIG. 1. In the example shown, the system 200 includes a display module 290 and an optical waveguide 250.

The display module 290 may be adapted to project plurality of light rays to the input coupler region 210 of the optical waveguide. Light rays corresponding to one pixel of the displayed image are shown in the environment 200 as the beams B1. The display module 290 may be operatively coupled to the controller 120 (not pictured). The controller 120 may provide suitable control signals that, when received by the display module 290, cause the desired display image to be formed.

The optical waveguide 250 may include a plurality of internally-reflective surfaces including a front surface 205, a rear surface 206, a top surface 203, a bottom surface 204, a left-side surface 201, and a right-side surface 202. Light rays that in-couple into the optical waveguide 250 are essentially guided within the waveguide 250 by the front surface 205 and the rear surface 206 because the thickness of the optical waveguide 250 may be very small.

The optical waveguide 250 may be made from a substrate that is substantially transparent to light rays received normal to the front surface 205 in the z direction. Light rays received normal to the front surface 205 may pass through the front surface 205 and the rear surface 206 to an eye 280 of a wearer of the HMD device 100 that includes the optical waveguide 250. Thus, when the optical waveguide 250 is positioned in front of the eye 280 of the wearer of the HMD device 100, the optical waveguide 250 does not obstruct the ability of the wearer to view external imagery.

The optical waveguide 250 further includes an in-coupling region 210 on the front surface 205. The in-coupling region 210 may receive one or more of the beams B1 from the display module 290, and may cause a portion of the beams B1 to enter the optical waveguide 250 (i.e., in-couple). As described further below, the in-coupling region 210 may comprise one or more grating structures.

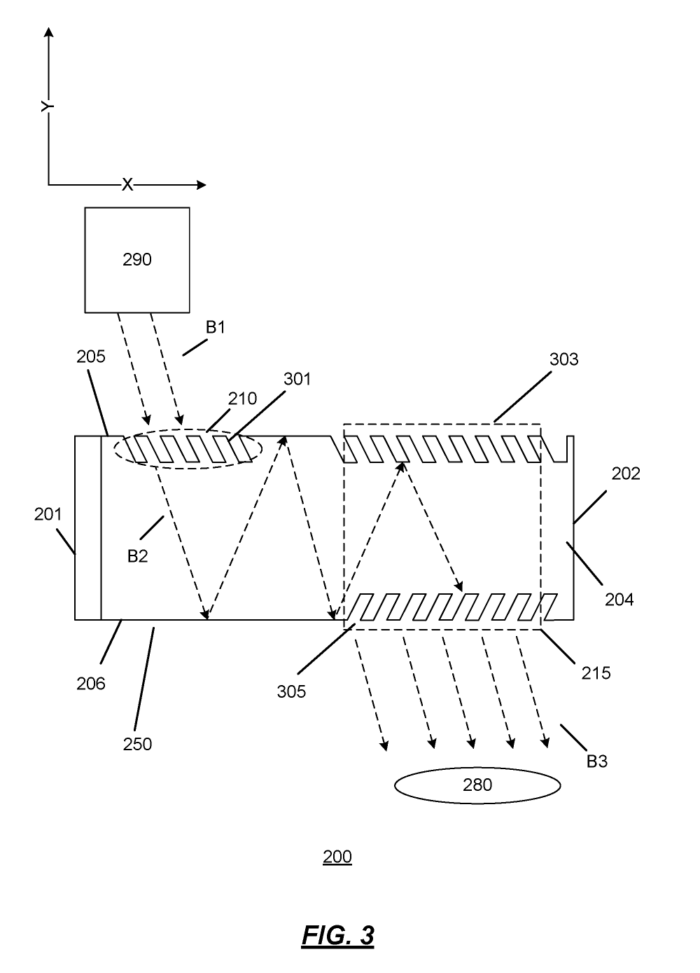

The optical waveguide 250 may further include an intermediate expander region 212. The intermediate expander region 212 may receive beams B2 (shown in FIG. 3) that were in-coupled into the optical waveguide 250 from the beams B1, and may implement a desired optical function such as pupil expansion. Like the in-coupling region 210, the intermediate expander region 212 may comprise one or more grating structures.

The optical waveguide 250 may further include an out-coupling region 215 on the rear surface 206, the front surface 205, or both the rear surface 206 and the front surface 205. The out-coupling region 215 may receive the beams B2 propagating through the optical waveguide 250 and may cause the beams B2 to exit (i.e., out-couple) the optical waveguide 250 as the beams B3. Each beam B3 may leave the out-coupling region 215 of the rear surface 206 through an exit pupil. The beams B3 may form the eye box, and may be received by the eye 280 of a wearer of the HMD device 100. The beams B3 may be a pupil expansion of the beams B1 output by the display module 290 and received by the in-coupling region 210.

FIG. 3 is an illustration of a side view of the exemplary near-eye display system 200. In the example shown, the optical waveguide 250 further includes a grating structure 301, a grating structure 303, and a grating structure 305. Each of the grating structures 301, 303, and 305 may be a surface-relief diffraction grating (“SRG”).

The grating structure 301 may form the in-coupling region 210, and the grating structures 303 and 305 may form the out-coupling region 215. The grating structures 303 and 305 together may be an example of a double-sided grating structure, because the grating structures 303 and 305 are formed on the front surface 205 and the rear surface 206, respectively. The grating structure 301 is an example of a single-sided grating structure because it is only on the front surface 205. In other implementations, either the in-coupling region 210 or the out-coupling region 215 may be formed by double-sided grating structures or single-siding grating structures.

In the example shown in FIG. 3, the beams B1 are in-coupled by the grating structure 301 of the in-coupling region 210, and are caused to traverse inside the optical waveguide 250 in the x direction and the y direction by the intermediate expander region 212 as the beams B2. For purposes of illustration, the intermediate expander region 212 is not shown in FIG. 3, but like the regions 210 and 215, the region 212 may be formed using one or more grating structures applied to one or both of the front surface 205 and the rear surface 206 of the optical waveguide 250.

Finally, when the beams B2 reach the out-coupling region 215, they are caused to exit from the optical waveguide 250 as the beams B3. The beams B3 may be caused to out-couple by either of the grating structure 303 or the grating structure 305.

The parameters associated with a grating structure may include, but are not limited to, grating period, grating line width, grating fill factor, grating depth, slant angle, line shape, surface pattern, and modulation direction. Configuration of the grating structures 301, 303, and 305 using the various parameters to achieve a desired purpose or function of the optical waveguide 250 is well understood in the art.

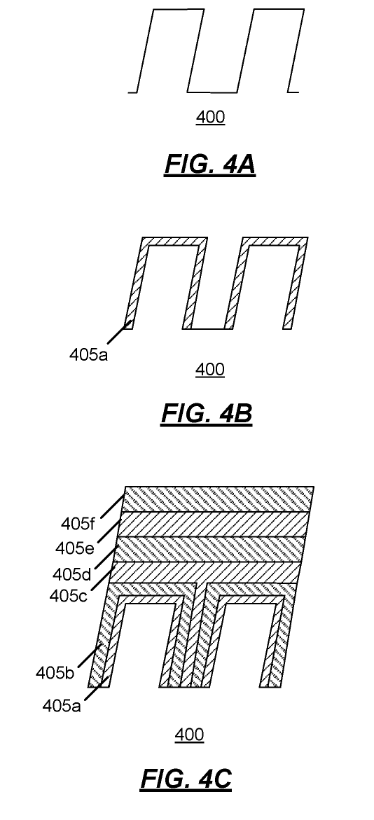

One method for forming a grating structure, such as a surface relief grating, is to etch the grating into the surface of the substrate that is used to form the optical waveguide 250. However, etching such grating structures into the glass substrate is expensive and time consuming, which has led to the use of other materials for the grating structures. Rather than etch the grating structure out of the same material as the optical waveguide 250, the grating structure can be formed from a different and more easily manipulated material. Example materials include a curable resin. A portion of such a grating structure is illustrated in FIG. 4A as the grating structure 400.

However, such alternative materials often have low refractive indexes (e.g., ˜1.5-1.7), which may result in low diffraction efficiency at certain wavelengths and angles of incidence of light rays. Low diffraction efficiency may result in limited efficiency of the optical waveguide at certain positions over the field of view. Limited fields of view may render such optical waveguides 250 unsuitable for AR or VR applications.

One solution to the problem of low diffraction efficiency is embedding of the grating structure in a suitable coating. FIG. 4B is an illustration of the grating structure 400 that has been embedded in a coating 405a. The coating 405a may have a higher refractive index relative to the refractive index of the grating structure 400. The difference between the refractive index of the grating structure 400 and the coating 405a may be at least 0.4.

Depending on the implementation, the coating 405a may be a conformal coating made of a material such as aluminum dioxide, titanium dioxide, or some combination thereof and may have refractive indexes up to 2.5. The coating 405a may have a thickness of between 50-300 nm. Other thicknesses may be used depending on the configuration and desired optical properties of the associated waveguide 250.

While the application of the coating 405a improves the efficiency and angular bandwidth of the grating structure 400, it may also introduce additional problems such as reflections in the in-coupling region. Incorporating the grating structure 400 with the coating 405a into the in-coupling region 210 may result in ghosting and image instability due to the reflections. Incorporating the grating structure 400 with the coating 405a into the out-coupling region 215 may result in a decreased opacity of the optical waveguide 250, which may render it unsuitable for AR applications.

For example, in a case where layers added on top of the grating structure 400 have a refractive index higher than the optical waveguide 250, they may form an additional waveguide where the light is confined to be guided within the layers. The number of guided modes in this thin-film waveguide can be quite small if the thickness of the layer stack is small. The grating structure 400 may couple light into these modes (as high diffraction orders), and when they are out-coupled again by the grating, this interference can be seen as nonuniformity across field-of-view.

To solve the above issues with respect to the coating 405a, additional antireflective coatings may be applied to the grating structure 400. An example grating structure 400 is illustrated in FIG. 4C. As shown in FIG. 4C, additional antireflective coatings 405b, 405c, 405d, 405e, and 405f have been applied to the optical waveguide 400. The coatings 405b, 405c, 405d, 405e, and 405f may together form an antireflective coating structure or layer and may reduce reflections caused by burying or coating the grating structure 400 in the coating 405a. Note that the actual number of coatings 405b, 405c, 405d, 405e, and 405f that are applied to the grating structure 400 is not limited to five and in some implementations more or fewer coatings 405 may be applied. For example, twenty or more additional coatings 405 may be applied, or a single coating 405 may be applied. Moreover, the type and thickness or the refractive index of each of the additional coatings 405 may be the same or different depending on the implementation, and the desired properties of the associated grating 400.

Because the grating structure 400 is already buried in the coating 405a, the additional coatings 405a-f cannot be applied to the grating structure 400 in the same way that the coating 405a was applied. First, while not visible in FIG. 4B, the application of the coating 405a onto the non-planar surfaces of the grating structure 400 results in the coating 405a having a strongly curved surface. This curved surface can make applying subsequent coatings 405 difficult.

Second, while the coating 405a on the grating 400 prevents certain high-diffraction orders of light from becoming trapped inside of the waveguide 250, the additional coatings 405b, 405c, 405d, 405e, and 405f, if not applied correctly, may trap the high-diffraction orders of light, and may allow the high-diffraction orders of light to propagate within one or more of the coatings 405b, 405c, 405d, 405e, and 405f. These propagating high-diffraction orders of light may cause interference effects with respect to some of the pixels of the display image. Such interference may make the grating structure 400 unsuitable for both AR and VR applications.

To prevent or manage these high-diffraction orders of light, the thickness of the coatings 405 applied to the coating 405a may be carefully selected. In a first implementation, the high-diffraction orders of light may be eliminated by applying additional coatings 405 that are extremely thin. The coatings 405 may be thin enough that any light that enters any of the coatings 405 behaves as if all of the coatings 405 are a single layer with a continuous modulation of refractive index, rather than individual discrete layers. By using thin coatings, the total number of guided modes that are associated with the resulting grating structure 400 is reduced.

Depending on the implementation, the thickness of each coating 405 may between several nanometers and several hundred nanometers. In addition, the total thickness of the coatings 405 applied to the coating 405a and the grating structure 400 (i.e., the coatings 405b, 405c, 405d, 405e, and 405f) may be thin enough to avoid additional interference effects. For example, the total thickness of the antireflective structure formed by all of the coatings 405 together may be around 10 micrometers while each of the coatings 405 is very thin.

In a second implementation, rather than very thin coatings 405, extremely thick coatings 405 may be applied to the coating 405a and the grating structure 400. Each coating 405 may have a thickness that is greater than 0.1 millimeters. Depending on the implementation, the total number of coatings 405 applied to the coating 405a and the grating structure 400 (i.e., the coatings 405b, 405c, 405d, 405e, and 405f) may be between 1 and 100.

In contrast with the first implementation, by using very thick coatings 405, the total number of guided modes that are associated with the resulting grating structure 400 is increased rather than decreased. However, because the resulting interference pattern is so dense and uniform across all pixels of the display image, the interference may not be noticeable to a viewer of the display image and/or the display image may be easily adjusted to account for the interference.

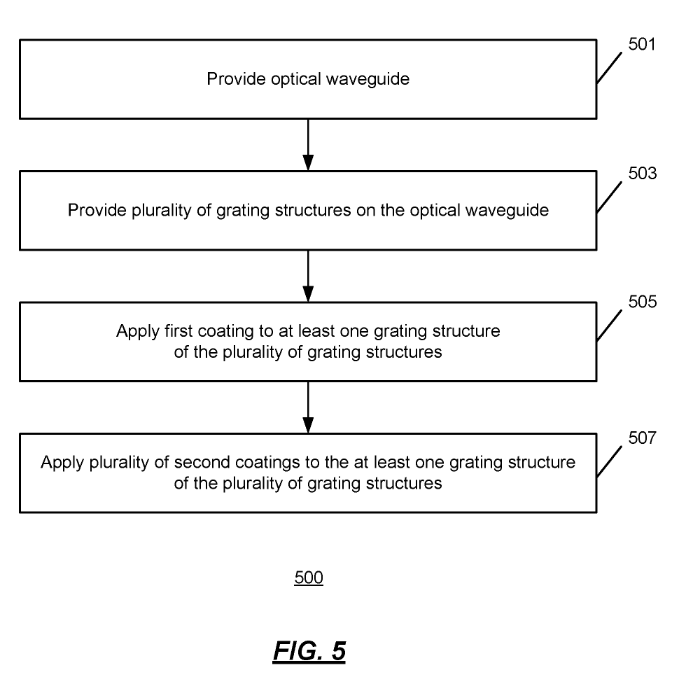

FIG. 5 is an operational flow of an implementation of a method 500 for coating one or more grating structures on an optical waveguide 250. At 501, an optical waveguide is provided. The optical waveguide 250 may be made out of a substrate such as glass and may allow light received at a front surface 205 to pass through the optical waveguide 205 and exit from a rear surface 206. The optical waveguide 250 may be configured to be used for a variety of VR and AR applications in a HMD 100, for example.

At 503, a plurality of grating structures is provided. The plurality of grating structures may form an in-coupling region 210, an intermediate expander region 212, and an out-coupling region 215. The grating structures may be a variety of types including surface relief gratings. Other types of grating structures may be supported. The grating structures may be etched or formed directly into one or more surfaces of the optical waveguide 250, or may be made from a different material and applied to the one or more surfaces of the optical waveguide 250.

At 505, a first coating is applied to the at least one grating structure of the plurality of grating structures. The first coating may be a conformal coating and may be applied directly on top of the at least one grating structure. A difference between the refractive index of the grating structure and the refractive index of the first coating may be greater than 0.4. Any type of conformal coating may be used.

At 507, a plurality of second coatings are applied to the at least one grating structure of the plurality of grating structures. The plurality of second coatings may be antireflective coatings applied directly to the first coating. Depending on the implementation, the plurality of second coatings may be very thin coatings or very thick coatings. The plurality of second coatings may be used to reduce any reflections into the optical waveguide 250 caused by the first coating. Each second coating may have a different thickness and refractive index. The plurality of second coatings may together form an antireflective structure that reduces reflections in the optical waveguide 250 caused by the first coating.

In implementations where the plurality of second coatings are very thin, the second coatings may be nanolaminates and each second coating may have a thickness that is several nanometers. The thinness may allow the plurality of second coatings to provide a small number of guided modes for light refracted by the first coating and trapped in the plurality of second coatings. By reducing the number of guided modes, the total number of pixels of the display image that are affected by interference is reduced.

In implementations where the plurality of second coatings are very thick, the second coatings may each be several millimeters. The thickness of the second coatings may allow the plurality of second coatings to provide a large number of guided modes for the light refracted by the first coating and trapped in the plurality of second coatings. By increasing the number of guided modes, the interference caused by the trapped light may become uniform across all of the pixels of the display image, and may be become imperceptible to a viewer of the display image or may be easily compensated for.

In an implementation, an optical waveguide for providing pupil expansion for augmented reality and virtual reality applications is provided. The optical waveguide includes a light-transmissive substrate including a plurality of internally reflective surfaces; a first diffractive optical element formed on a first surface of the plurality of internally reflective surfaces, wherein the first diffractive optical element is adapted to in-couple light into the optical waveguide; and a second diffractive optical element formed on the first surface or a second surface of the plurality of internally reflective surfaces and adapted to out-couple light from the optical waveguide, wherein the second diffractive optical element includes: a diffraction relief grating structure; a first coating, wherein the diffraction relief grating structure is embedded in the first coating; and a plurality of second coatings forming an anti-reflective structure that reduces reflections associated with the first coating.

Implementations may include some or all of the following features. The diffraction relief grating structure may include a surface relief grating. Each second coating of the plurality of second coatings may have a thickness of between 1 and 10 nanometers. A total thickness of the second coatings may be less than 2 micrometers. The plurality of second coatings may prevent the light from in-coupling into the plurality of second coatings. The plurality of second coatings may allow the light to in-couple into the plurality of second coatings. A total thickness of the plurality of second coatings may be greater than 10 micrometers. At least one coating of the plurality of second coatings may have a thickness and a refractive index that are different than a thickness and a refractive index of another coating of the plurality of second coatings.

In an implementation, an optical waveguide is provided. The optical waveguide includes: a light-transmissive substrate including a plurality of internally reflective surfaces; and a diffractive optical element formed on a first surface of the plurality of internally reflective surfaces, wherein the diffractive optical element includes: a diffraction relief grating structure; a first coating, wherein the diffraction relief grating structure is embedded in the first coating; and a second coating, wherein the second coating reduces one or more reflections associated with the first coating.

Implementations may include some or all of the following features. The diffraction relief grating structure may include a surface relief grating. The second coating may include a plurality of antireflective coatings. At least one antireflective coating of the plurality of antireflective coatings may have a thickness and a refractive index that are different than a thickness and a refractive index of another antireflective coating of the plurality of antireflective coatings. Each antireflective coating of the plurality of antireflective coatings may have a thickness of between 1 nanometer and 100 nanometers.

In an implementation, a head mounted display device is provided. The head mounted display includes: a display module; a controller coupled to the display module and configured to cause the display module to project a beam of light; and an optical waveguide, wherein the optical waveguide includes: a light-transmissive substrate including a plurality of internally reflective surfaces; and a diffractive optical element formed on a surface of the plurality of internally reflective surfaces, wherein the diffractive optical element includes: a diffraction relief grating structure; a first coating, wherein the diffraction relief grating structure is embedded in the first coating; and a second coating, wherein the second coating reduces one or more reflections associated with the first coating.

Implementations may include some or all of the following features. The diffraction relief grating structure may include a surface relief grating. The second coating may include a plurality of antireflective coatings. Each antireflective coating of the plurality of antireflective coatings may have a thickness of between 2 nanometers and 10 nanometers. The second coating may have a thickness of between 1 and 2 micrometers. At least one antireflective coating of the plurality of antireflective coatings has a thickness and a refractive index that are different than a thickness and a refractive index of another antireflective coating of the plurality of antireflective coatings. The second coating may allow some of the beam of light to in-couple into the second coating.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. An optical waveguide for providing pupil expansion for augmented reality and virtual reality applications, the optical waveguide comprising:
a light-transmissive substrate including a plurality of internally reflective surfaces;
a first diffractive optical element formed on a first surface of the plurality of internally reflective surfaces, wherein the first diffractive optical element is adapted to in-couple light into the optical waveguide; and
a second diffractive optical element formed on the first surface or a second surface of the plurality of internally reflective surfaces and adapted to out-couple light from the optical waveguide, wherein the second diffractive optical element comprises:
a diffraction relief grating structure;
a first coating, wherein the diffraction relief grating structure is embedded in the first coating; and
a plurality of second coatings forming an anti-reflective structure that reduces reflections associated with the first coating.

2. The optical waveguide of claim 1, wherein the diffraction relief grating structure comprises a surface relief grating.

3. The optical waveguide of claim 1, wherein each second coating of the plurality of second coatings has a thickness of between 1 nanometer and 100 nanometers.

4. The optical waveguide of claim 1, wherein a total thickness of the second coatings is less than 2 micrometers.

5. The optical waveguide of claim 1, wherein the plurality of second coatings prevents the light from in-coupling into the plurality of second coatings.

6. The optical waveguide of claim 1, wherein the plurality of second coatings allows the light to in-couple into the plurality of second coatings.

7. The optical waveguide of claim 1, wherein a total thickness of the plurality of second coatings is greater than 10 micrometers.

8. The optical waveguide of claim 1, wherein at least one coating of the plurality of second coatings has a thickness and a refractive index that are different than a thickness and a refractive index of another coating of the plurality of second coatings.

9. An optical waveguide comprising:
a light-transmissive substrate including a plurality of internally reflective surfaces; and
a diffractive optical element formed on a first surface of the plurality of internally reflective surfaces, wherein the diffractive optical element comprises:
a diffraction relief grating structure;
a first coating, wherein the diffraction relief grating structure is embedded in the first coating; and
a second coating, wherein the second coating reduces one or more reflections associated with the first coating.

10. The optical waveguide of claim 9, wherein the diffraction relief grating structure comprises a surface relief grating.

11. The optical waveguide of claim 9, wherein the second coating comprises a plurality of antireflective coatings.

12. The optical waveguide of claim 11, wherein at least one antireflective coating of the plurality of antireflective coatings has a thickness and a refractive index that are different than a thickness and a refractive index of another antireflective coating of the plurality of antireflective coatings.

13. The optical waveguide of claim 11, wherein each antireflective coating of the plurality of antireflective coatings has a thickness of between 1 nanometer and 100 nanometers.

14. A head mounted display device comprising:
a display module;
a controller coupled to the display module and configured to cause the display module to project a beam of light; and
an optical waveguide, wherein the optical waveguide comprises:
a light-transmissive substrate including a plurality of internally reflective surfaces; and
a diffractive optical element formed on a surface of the plurality of internally reflective surfaces, wherein the diffractive optical element comprises:
a diffraction relief grating structure;
a first coating, wherein the diffraction relief grating structure is embedded in the first coating; and
a second coating, wherein the second coating reduces one or more reflections associated with the first coating.

15. The head mounted display device of claim 14, wherein the diffraction relief grating structure comprises a surface relief grating.

16. The head mounted display device of claim 14, wherein the second coating comprises a plurality of antireflective coatings.

17. The head mounted display device of claim 16, wherein each antireflective coating of the plurality of antireflective coatings has a thickness of between 2 nanometers and 100 nanometers.

18. The head mounted display device of claim 16, wherein at least one antireflective coating of the plurality of antireflective coatings has a thickness and a refractive index that are different than a thickness and a refractive index of another antireflective coating of the plurality of antireflective coatings.

19. The head mounted display device of claim 14, wherein the second coating has a thickness of between 1 micrometer and 2 micrometers.

20. The head mounted display device of claim 14, wherein the second coating allows some of the beam of light to in-couple into the second coating.
